(19) United States
(12) Patent Application Publication
(10) Pub. No.: US 2023/0174069 A1
(43) Pub. Date: Jun. 8, 2023

(54) DRIVING CONTROL APPARATUS

(71) Applicant: Honda Motor Co., Ltd., Tokyo (JP)

(72) Inventors: Shun Iwasaki, Wako-shi (JP); Nana Niibo, Wako-shi (JP); Naoto Hiramatsu, Wako-shi (JP)

(21) Appl. No.: 17/891,246

(22) Filed: Aug. 19, 2022

(30) Foreign Application Priority Data
Aug. 27, 2021 (JP) 2021-138580

(51) Int. Cl. B60W 30/18; B60W 60/00; B60W 30/12; B60W 40/06

(52) U.S. Cl. CPC B60W 30/18163; B60W 60/001; B60W 30/12; B60W 40/06; B60W 2554/4041; B60W 2554/80

(57) ABSTRACT

A driving control apparatus includes: an in-vehicle detector configured to detecting a situation around a vehicle; and a microprocessor and a memory coupled to the microprocessor. The microprocessor is configured to perform: recognizing an object in a predetermined area set in front of the vehicle base on the situation detected by the in-vehicle detector; calculating a reliability of a recognition result of the object in the recognizing; and controlling an actuator for traveling based the recognition result. The microprocessor is configured to perform the controlling including controlling, when the reliability calculated in the calculating is equal to or less than a predetermined value, the actuator so that the vehicle approaches the object recognized in the recognizing with a predetermined deceleration, while controlling, when the reliability calculated in the calculating is larger than the predetermined value, the actuator so that the vehicle approaches the object based on the position of the vehicle and the object.

### CROSS-REFERENCE TO RELATED APPLICATION

This application is based upon and claims the benefit of priority from Japanese Patent Application No. 2021-138580 filed on Aug. 27, 2021, the content of which are incorporated herein by reference.

### BACKGROUND OF THE INVENTION

### Field of the Invention

This invention relates to a driving control apparatus configured to control traveling of a vehicle.

### Description of the Related Art

As this type of device, there is conventionally a known apparatus that, corrects the target travel path so that the distance in the vehicle width direction between the preceding vehicle is kept by distance corresponding to the relative speed with the preceding vehicle when passing through the side of the preceding vehicle traveling in front of the vehicle (for example, see JP2019-142303A).

However, in the apparatus described in the above JP2019-142303A, when the preceding vehicle is recognized, the target travel route is immediately corrected without depending on the recognition accuracy, so that the target travel route may not be correctly set and appropriate travel may not be possible.

### SUMMARY OF THE INVENTION

An aspect of the present invention is a driving control apparatus includes: an in-vehicle detector configured to detecting a situation around a vehicle; and a microprocessor and a memory coupled to the microprocessor. The microprocessor is configured to perform: recognizing an object in a predetermined area set in front of the vehicle base on the situation detected by the in-vehicle detector; calculating a reliability of a recognition result of the object in the recognizing; and controlling an actuator for traveling based the recognition result. The microprocessor is configured to perform the controlling including controlling, when the reliability calculated in the calculating is equal to or less than a predetermined value, the actuator so that the vehicle approaches the object recognized in the recognizing with a predetermined deceleration, while controlling, when the reliability calculated in the calculating is larger than the predetermined value, the actuator so that the vehicle approaches the object based on the position of the vehicle and the object.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system including a driving control apparatus according to an embodiment of the present invention;

FIG. 2 is a diagram showing an example of a driving scene to which the traveling control apparatus according to the embodiment of the present invention is applied;

FIG. 3 is a block diagram showing a configuration of a main part of the driving control apparatus according to the embodiment of the present invention;

FIG. 4A is a diagram for explaining an acquisition area;

FIG. 4B is a diagram for explaining the acquisition area;

FIG. 5 is a flowchart showing an example of processing executed by the controller of FIG. 3;

FIG. 6 is a diagram for explaining an example of an operation of the driving control apparatus;

FIG. 7 is a diagram for explaining another example of an operation of the driving control apparatus;

FIG. 8 is a diagram for explaining another example of an operation of the driving control apparatus;

FIG. 9 is a diagram for explaining another example of an operation of the driving control apparatus;

FIG. 10 is a diagram for explaining another example of an operation of the driving control apparatus; and

FIG. 11 is a diagram for explaining offsets of the acquisition area;

### DETAILED DESCRIPTION OF THE INVENTION

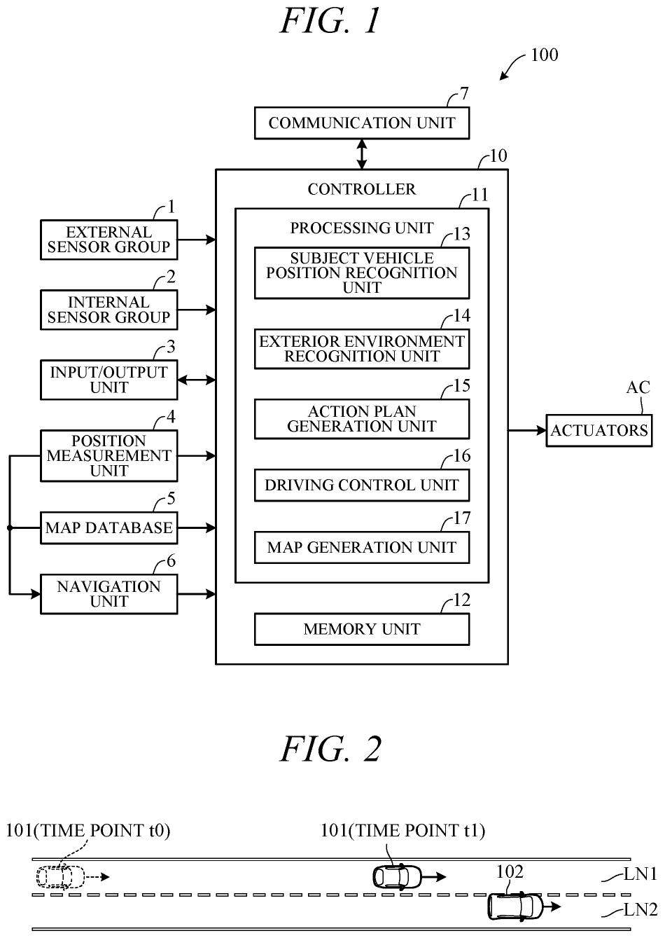

An embodiment of the present invention will be described below with reference to FIGS. 1 to 11. A driving control apparatus according to the embodiment of the present invention can be applied to a vehicle having a self-driving capability, that is, a self-driving vehicle. Note that a vehicle to which the position recognition apparatus according to the present embodiment is applied may be referred to as a subject vehicle to be distinguished from other vehicles. The subject vehicle may be any of an engine vehicle including an internal combustion (engine) as a traveling drive source, an electric vehicle including a traveling motor as a traveling drive source, and a hybrid vehicle including an engine and a traveling motor as a traveling drive source. The subject vehicle can travel not only in a self-drive mode in which a driving operation by a driver is unnecessary, but also in a manual drive mode by the driving operation by the driver.

First, a schematic configuration related to self-driving will be described. FIG. 1 is a block diagram schematically illustrating an overall configuration of a vehicle control system 100 including the driving control apparatus according to the embodiment of the present invention. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and actuators AC each communicably connected to the controller 10.

The external sensor group 1 is a generic term for a plurality of sensors (external sensors) that detects an external situation which is peripheral information of the subject vehicle. For example, the external sensor group 1 includes a LiDAR that measures scattered light with respect to irradiation light in all directions of the subject vehicle and measures a distance from the subject vehicle to surrounding obstacles, a radar that detects other vehicles, obstacles, and the like around the subject vehicle by emitting electromagnetic waves and detecting reflected waves, a camera that is mounted on the subject vehicle, has an imaging element such as a charge coupled device (CCD) or a complementary metal oxide semiconductor (CMOS), and images a periphery (forward, backward, and sideward) of the subject vehicle, and the like.

The internal sensor group 2 is a generic term for a plurality of sensors (internal sensors) that detects a traveling state of the subject vehicle. For example, the internal sensor group 2 includes a vehicle speed sensor that detects a vehicle speed of the subject vehicle, an acceleration sensor that detects an acceleration in a front-rear direction of the subject vehicle and an acceleration in a left-right direction (lateral acceleration) of the subject vehicle, a revolution sensor that detects the number of revolution of the traveling drive source, a yaw rate sensor that detects a rotation angular speed around a vertical axis of the centroid of the subject vehicle, and the like. The internal sensor group 2 further includes a sensor that detects driver's driving operation in a manual drive mode, for example, operation of an accelerator pedal, operation of a brake pedal, operation of a steering wheel, and the like.

The input/output device 3 is a generic term for devices in which a command is input from a driver or information is output to the driver. For example, the input/output device 3 includes various switches to which the driver inputs various commands by operating an operation member, a microphone to which the driver inputs a command by voice, a display that provides information to the driver via a display image, a speaker that provides information to the driver by voice, and the like.

The position measurement unit (global navigation satellite system (GNSS) unit) 4 includes a position measurement sensor that receives a signal for position measurement transmitted from a position measurement satellite. The position measurement satellite is an artificial satellite such as a global positioning system (GPS) satellite or a quasi-zenith satellite. The position measurement unit 4 uses the position measurement information received by the position measurement sensor to measure a current position (latitude, longitude, and altitude) of the subject vehicle.

The map database 5 is a device that stores general map information used for the navigation unit 6, and is constituted of, for example, a hard disk or a semiconductor element. The map information includes road position information, information on a road shape (curvature or the like), position information on intersections and branch points, and information on speed limited on a road. Note that the map information stored in the map database 5 is different from highly accurate map information stored in a memory unit 12 of the controller 10.

The navigation unit 6 is a device that searches for a target travel route (hereinafter, simply referred to as target route on a road to a destination input by a driver and provides guidance along the target route. The input of the destination and the guidance along the target route are performed via the input/output device 3. The target route is calculated on the basis of a current position of the subject vehicle measured by the position measurement unit 4 and the map information stored in the map database 5. The current position of the subject vehicle can be also measured using the detection value of the external sensor group 1, and the target route may be calculated on the basis of the current position and the highly accurate map information stored in the memory unit 12.

The communication unit 7 communicates with various servers not illustrated via a network including wireless communication networks represented by the Internet, a mobile telephone network, and the like, and acquires the map information, traveling history information, traffic information, and the like from the server periodically or at an arbitrary timing. The network includes not only a public wireless communication network but also a closed communication network provided for each predetermined management region, for example, a wireless LAN, Wi-Fi (registered trademark), Bluetooth (registered trademark), and the like. The acquired map information is output to the map database 5 and the memory unit 12, and the map information is updated.

The actuators AC are traveling actuators for controlling traveling of the subject vehicle. In a case where the traveling drive source is an engine, the actuators AC include a throttle actuator that adjusts an opening (throttle opening) of a throttle valve of the engine. In a case where the traveling drive source is a traveling motor, the traveling motor is included in the actuators AC. The actuators AC also include a brake actuator that operates a braking device of the subject vehicle and a steering actuator that drives a steering device.

The controller 10 includes an electronic control unit (ECU). More specifically, the controller 10 includes a computer that has a processing unit 11 such as a central processing unit (CPU) (microprocessor), the memory unit 12 such as a read only memory (ROM) and a random access memory (RAM), and other peripheral circuits (not illustrated) such as an input/output (I/O) interface. Note that although a plurality of ECUs having different functions such as an engine control ECU, a traveling motor control ECU, and a braking device ECU can be separately provided, in FIG. 1, the controller 10 is illustrated as a set of these ECUs for convenience.

The memory unit 12 stores highly accurate detailed map information (referred to as highly accurate map information). The highly accurate map information includes road position information, information of a road shape (curvature or the like), information of a road gradient, position information of an intersection or a branch point, information of the number of lanes, width of a lane and position information for each lane (information of a center position of a lane or a boundary line of a lane position), position information of a landmark (traffic lights, signs, buildings, etc.) as a mark on a map, and information of a road surface profile such as unevenness of a road surface. The highly accurate map information stored in the memory unit 12 includes map information acquired from the outside of the subject vehicle via the communication unit 7, for example, information of a map (referred to as a cloud map) acquired via a cloud server, and information of a map created by the subject vehicle itself using detection values by the external sensor group 1, for example, a map (referred to as an environmental map) including point cloud data generated by mapping using a technology such as simultaneous localization and mapping (SLAM). The memory unit 12 also stores information on information such as various control programs and threshold values used in the programs.

The processing unit 11 includes a subject vehicle position recognition unit 13, an exterior environment recognition unit 14, an action plan generation unit 15, a driving control unit 16, and a map generation unit 17 as functional configurations.

The subject vehicle position recognition unit 13 recognizes the position (subject vehicle position) of the subject vehicle on a map, on the basis of the position information of the subject vehicle, obtained by the position measurement unit 4, and the map information of the map database 5. The subject vehicle position may be recognized using the map information stored in the memory unit 12 and the peripheral information of the subject vehicle detected by the external sensor group 1, whereby the subject vehicle position can be recognized with high accuracy. Note that when the subject vehicle position can be measured by a sensor installed on the road or outside a road side, the subject vehicle position can be recognized by communicating with the sensor via the communication unit 7.

The exterior environment recognition unit 14 recognizes an external situation around the subject vehicle on the basis of the signal from the external sensor group 1 such as a LiDAR, a radar, and a camera. For example, the position, travel speed, and acceleration of a surrounding vehicle (a forward vehicle or a rearward vehicle) traveling around the subject vehicle, the position of a surrounding vehicle stopped or parked around the subject vehicle, the positions and states of other objects and the like are recognized. Other objects include signs, traffic lights, markings (road marking) such as division lines and stop lines of roads, buildings, guardrails, utility poles, signboards, pedestrians, bicycles, and the like. The states of other objects include a color of a traffic light (red, blue, yellow), the moving speed and direction of a pedestrian or a bicycle, and the like.

The action plan generation unit 15 generates a driving path (target path) of the subject vehicle from a current point of time to a predetermined time T ahead on the basis of, for example, the target route calculated by the navigation unit 6, the subject vehicle position recognized by the subject vehicle position recognition unit 13, and the external situation recognized by the exterior environment recognition unit 14. When there is a plurality of paths that are candidates for the target path on the target route, the action plan generation unit 15 selects, from among the plurality of paths, an optimal path that satisfies criteria such as compliance with laws and regulations and efficient and safe traveling, and sets the selected path as the target path. Then, the action plan generation unit 15 generates an action plan corresponding to the generated target path. The action plan generation unit 15 generates various action plans corresponding to travel modes, such as overtaking traveling for overtaking a preceding vehicle, lane change traveling for changing a travel lane, following traveling for following a preceding vehicle, lane keeping traveling for keeping the lane so as not to deviate from the travel lane, deceleration traveling, or acceleration traveling. When the action plan generation unit 15 generates the target path, the action plan generation unit 15 first determines a travel mode, and generates the target path on the basis of the travel mode.

In the self-drive mode, the driving control unit 16 controls each of the actuators AC such that the subject vehicle travels along the target path generated by the action plan generation unit 15. More specifically, the driving control unit 16 calculates a requested driving force for obtaining the target acceleration for each unit time calculated by the action plan generation unit 15 in consideration of travel resistance determined by a road gradient or the like in the self-drive mode. Then, for example, the actuators AC are feedback controlled so that an actual acceleration detected by the internal sensor group 2 becomes the target acceleration. That is, the actuators AC are controlled so that the subject vehicle travels at the target vehicle speed and the target acceleration. Note that, in the manual drive mode, the driving control unit 16 controls each of the actuators AC in accordance with a travel command (steering operation or the like) from the driver acquired by the internal sensor group 2.

The map generation unit 17 generates the environmental map constituted by three-dimensional point cloud data using detection values detected by the external sensor group 1 during traveling in the manual drive mode. Specifically, an edge indicating an outline of an object is extracted from a captured image acquired by a camera 1a on the basis of luminance and color information for each pixel, and a feature point is extracted using the edge information. The feature point is, for example, an intersection of the edges, and corresponds to a corner of a building, a corner of a road sign, or the like. The map generation unit 17 sequentially plots the extracted feature points on the environmental map, thereby generating the environmental map around the road on which the subject vehicle has traveled. The environmental map may be generated by extracting the feature point of an object around the subject vehicle using data acquired by radar or LiDAR instead of the camera. Further, when generating the environmental map, the map generation unit 17 determines whether a landmark such as a traffic light, a sign, or a building as a mark on the map is included in the captured image acquired by the camera by, for example, pattern matching processing. When it is determined that the landmark is included, the position and the type of the landmark on the environmental map are recognized on the basis of the captured image. The landmark information is included in the environmental map and stored in the memory unit 12.

The subject vehicle position recognition unit 13 performs subject vehicle position estimation processing in parallel with map creation processing by the map generation unit 17. That is, the position of the subject vehicle is estimated on the basis of a change in the position of the feature point over time to be acquired. Further, the subject vehicle position recognition unit 13 estimates the subject vehicle position on the basis of a relative positional relationship with respect to a landmark around the subject vehicle to be acquired. The map creation processing and the position estimation processing are simultaneously performed, for example, according to an algorithm of SLAM.

FIG. 2 is a diagram showing an example of a driving scene to which the traveling control apparatus according to the present embodiment is applied. FIG. 2 shows a left-hand traffic two-lane road on one side, where the subject vehicle 101 is traveling in a lane LN1 and the other vehicle 102 is traveling in a lane LN2 adjoining the lane LN1. Incidentally, in FIG. 2, for simplicity of the drawing, the lanes LN3, LN4 that is the opposing lanes is omitted.

In the situation shown in FIG. 2, if the subject vehicle 101 continues to run as it is from the present time (time t1), since the other vehicle 102 is traveling close to the left side in the lane LN2, the subject vehicle 101 approaches the other vehicle 102 when passing through the side of the other vehicle 102, there is a risk that the occupants of both vehicles may be psychologically compressed. Therefore, when the subject vehicle 101 recognizes the other vehicle 102 ahead at the time point t0, the subject vehicle 101 performs a route change (a route change in a direction away from the other vehicle 102) and passes the side of the other vehicle 102 by while decelerating.

Incidentally, the longer the distance between the subject vehicle 101 and the other vehicle 102 at the time t0 is when the subject vehicle 101 recognizes the other vehicle 102, the lower the recognition accuracy of the other vehicle 102 is. Therefore, even though the other vehicle 102 is traveling in the center of the lane LN2, the subject vehicle 101 may erroneously recognize that the other vehicle 102 is traveling on the lane LN2 closer to lane LN1 of its own lane and start deceleration control. In that case, for the first time when approaching the other vehicle 102 to a certain extent, the subject vehicle 101 recognizes that the other vehicle 102 is traveling in the center of the lane LN2, and starts the acceleration control so as to return the vehicle speed reduced by the deceleration control to the original speed. Thus, when the position in the vehicle width direction of the other vehicle 102 cannot be accurately recognized, hunting of the route change in addition to hunting of the acceleration and deceleration of the subject vehicle 101 is also occurred, there is a possibility that an impression as if the subject vehicle 101 is wandering is given to the occupant.

The hunching of acceleration and deceleration or the hunching of route change as described above may cause psychological compression or discomfort to the occupant. Therefore, in consideration of this point, in the present embodiment, the driving control apparatus is configured as follows.

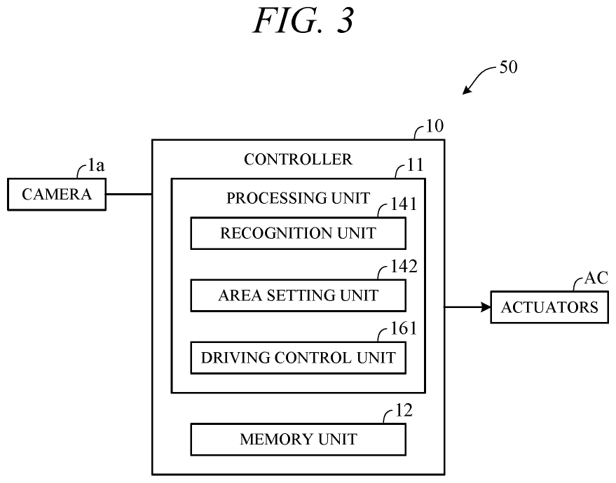

FIG. 3 is a block diagram showing a configuration of a main part of the driving control apparatus 50 according to the embodiment of the present invention. The driving control apparatus 50 controls the driving operation of the subject vehicle 101, and more specifically, the subject vehicle 101 controls the traveling actuator so as to approach the object in front (other vehicle), constitute a part of the vehicle control system 100 of FIG. 1. Incidentally, the operation of the subject vehicle 101 traveling so that the relative distance in the traveling direction to the object in front referred to as approach travel. As shown in FIG. 3, the driving control apparatus 50 includes a controller 10, a camera 1a, and actuators AC.

The camera 1a is a monocular camera having an imaging element (image sensor) such as a CCD or a CMOS, and constitutes a part of the external sensor group 1 in FIG. 1. The camera 1a may be a stereo camera. The camera 1a images the surroundings of the subject vehicle. The camera 1a is mounted at a predetermined position, for example, at the front of the subject vehicle, and continuously captures an image of a space in front of the subject vehicle to acquire an image data (hereinafter, referred to as captured image data or simply a captured image) of the object. The camera 1a outputs the captured image to the controller 10.

The controller 10 includes, as a functional configuration of the processing unit 11 (FIG. 1) is responsible, a recognition unit 141, an area setting unit 142, and a driving control unit 161. The recognition unit 141 and the area setting unit 142 constitutes a part of the exterior environment recognition unit 14. The driving control unit 161 constitutes a part of the action plan generation unit 15 and the driving control unit 16 performs a different control from the driving control unit 16 of FIG.

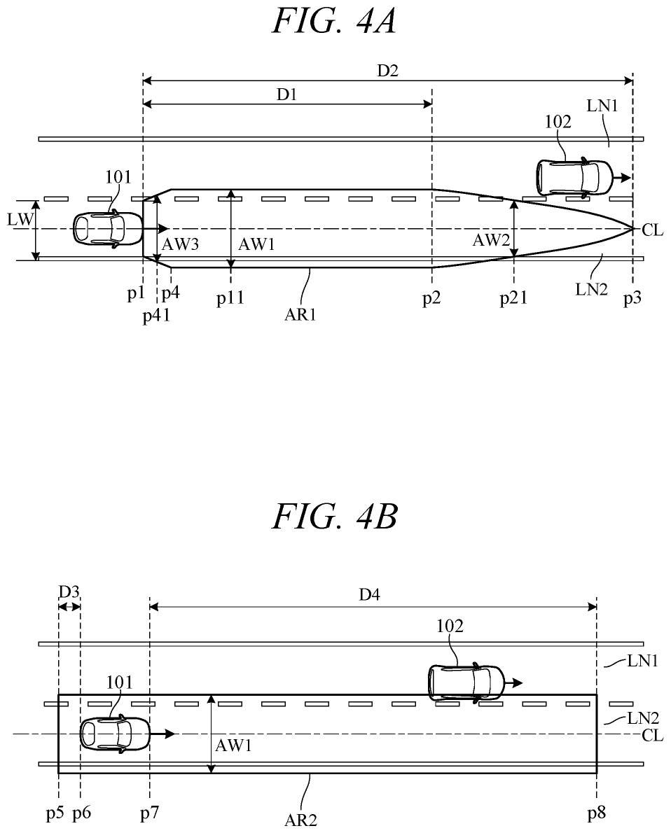

The recognition unit 141 recognizes an object in a predetermined area (hereinafter, referred to as an acquisition area) set in front of the subject vehicle 101 based on the surrounding condition detected by the camera 1a. FIG. 4A and FIG. 4B are diagrams for explaining the acquisition area.

The area setting unit 142 sets the area AR1 in front of the subject vehicle 101 as the acquisition area. As shown in FIG. 4A, the area AR1 is set so that the width (length in the vehicle width direction) AW2 at the position p21 ahead from the front end position p1 of the subject vehicle 101 by the distance D1 in the traveling direction is shorter than the width (length in the vehicle width direction) AW1 at the position p11 behind the position p2. The area AR1 is set such that the width AW1 is longer than the lane width LW. Furthermore, the width AW2 is gradually shortened in the traveling direction at a position from of the position p2, the width AW2 is 0 at a position p3 away from the subject vehicle 101 in the traveling direction by a distance D2. The line CL in the figure represents the center line of the lane LN1. When the subject vehicle 101 is traveling at the center position of the lane LN1, the center line of the acquisition area overlaps the center line CL of the lane LN1. On the other hand, when the traveling position of the subject vehicle 101 deviates from the center line CL of the lane LN1, the position of the center line of the acquisition area becomes a position shifted by an offset control target value from the center line CL of the lane LN1. The offset control target value is the deviation amount (offset amount) in the vehicle width direction from the center line CL in the lane LN1 of the travel path (target travel path) of the subject vehicle 101. In FIG. 4A, in order to explain the shape of the area AR1 ahead from the position p2 in traveling direction, for convenience, the distance from the position p2 to the position p3 is drawn shorter than the distance D1, the distance from the position p2 to the position p3 is preferably several times the length of the distance D1.

By setting the area AR1 as the acquisition area, for example, even when an object is recognized in a section forward in the traveling direction from the position p2, the object is hardly acquired. Thus, by the object is less likely to be acquired in the section (section ahead of the traveling direction from the position p2) where is assumed to be lower recognition accuracy of the object, it is possible to suppress hunting of acceleration and deceleration and rapid route change and deceleration due to erroneous recognition as described above. Further, by offsetting the area AR1 based on the offset control target value as described above, for example, when passing the side of the other vehicle 102, in a case where it is known that the distance of the subject vehicle 101 in the vehicle width direction with the other vehicle 102 is sufficiently ensured, that is, in a case where it may be unlikely to provide the occupant with a psychological compression due to the approach of both vehicles (approach in the vehicle width direction), the other vehicle 102 can be suppressed from being acquired unnecessarily. As a result, it is possible to suppress unnecessary execution of the pre-deceleration described later.

The area AR1 is set such that the width AW3 at the position p41 behind the position p4 which is distant from the front end position p1 of the subject vehicle 101 in the traveling direction by the distance D1 is shorter than the width AW1. The width AW1, considering the recognition error of the recognition unit 141, is set longer so as to add the error amount to the vehicle width. On the other hand, since the recognition error of the recognition unit 141 becomes smaller as the recognition position is closer to the subject vehicle 101, the width AW3 is set to a length shorter than the width AW1 so as to exclude the error.

The area setting unit 142 sets the area AR2 as the acquisition area when the object is acquired (recognized in the acquisition area) by the recognition unit 141 on condition that the area AR1 is set as the acquisition area. More specifically, the area setting unit 142, when the object is recognized in the area AR1 by the recognition unit 141, calculates the recognition accuracy (reliability to the recognition result), and then the area setting unit 142 sets the area AR2 as the acquisition area when the reliability is a predetermined threshold TH1 or more.

An object acquired at a position ahead of the position p2 in the traveling direction in the FIG. 4A is likely to be traveling closer to the subject vehicle 101 (the current lane LN2) even if the position of the object in the vehicle width direction is not accurately recognized. Therefore, when the object is acquired, the area setting unit 142 sets the area AR2 as the acquisition area to enlarge the acquisition area so that the object acquired once is easily acquired continuously.

As shown in FIG. 4B, the area AR2 is a rectangular area that has a width AW1 and is set between a position p5 that is separated by a distance D3 from the rear end position p6 of the subject vehicle 101 in a direction opposite to the traveling direction and a position p8 that is separated by a distance D4 from the front end position p7 of the subject vehicle 101 in the traveling direction. In this manner, by enlarging the acquisition area, the object that has been acquired once is likely to be continuously acquired. Further, by enlarging the acquisition area to the position p5 so that the rear end portion of the acquisition area is positioned at the position p5 behind the vehicle, it is possible to continue acquiring the object for a while after passing the side of the object. As shown in the FIG. 4B, the distance D4 may be set to the same length as the distance D2, or may be dynamically set based on the position of the object such that the acquired object (other vehicle 102) is included in the area AR2.

The recognition accuracy (reliability) is calculated as follows. First, the area setting unit 142, based on the captured image of the camera 1a, it is determined whether an object (an object ahead of the subject vehicle 101) included in the captured image is the object. For example, the area setting unit 142 performs feature point matching between the captured image and images (comparison images) of various objects (vehicles, persons, etc.) stored in advance in the storage unit 42, and recognizes the type of the object included in the captured image.

Next, the area setting unit 142 calculates the reliability of the recognition result. At this time, the area setting unit 142 calculates the reliability higher as the similarity is higher, based on the matching result of the feature point matching. Further, since the recognition accuracy of the position (the position in the vehicle width direction) of the object to be detected from the captured image is increased as the relative distance between the subject vehicle 101 and the object is shorter, the area setting unit 142 calculates the reliability higher as the relative distance between the subject vehicle 101 and the object is shorter. The reliability is, for example, expressed as a percentage. The method of calculating the reliability is not limited to this.

The driving control unit 161 controls the traveling actuators AC based on the recognition result of the object recognized by the recognition unit 141. Specifically, the driving control unit 161 performs an acceleration/deceleration control (acceleration control and deceleration control) for controlling the acceleration and deceleration of the subject vehicle 101 and a route change control for changing the travel route of the subject vehicle 101 on the basis of the reliability of the recognition result by the recognition unit 141 and the relative distance and the relative speed with respect to the object.

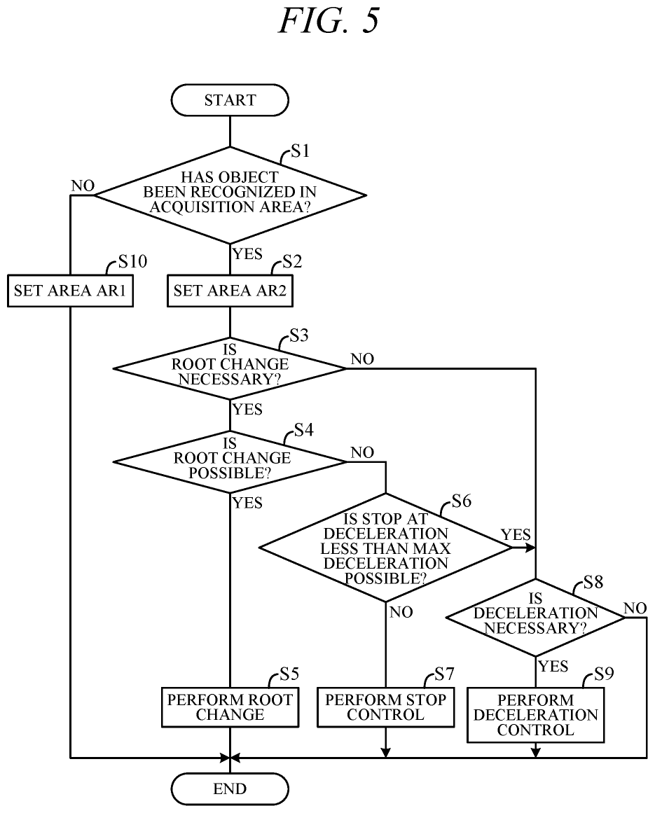

FIG. 5 is a flowchart showing an example of processing executed by the controller 10 of FIG. 3 in accordance with a predetermined program. The processing shown in the flowchart of FIG. 5 is repeated for example, every predetermined cycle (predetermined time T) while the subject vehicle 101 is traveling in the self-drive mode.

First, in step S1 (S: processing step), it is determined whether an object has been recognized in the acquisition area set in front of the subject vehicle 101. Incidentally, at the first execution of the process of FIG. 5, it is assumed that the area AR1 is set as the acquisition area. If the determination is negative in S1, in S10, the area AR1 is set in front of the subject vehicle 101 as the acquisition area, and the process ends. At this time, if the area AR1 has already been set as the acquisition area, the process skips S10 and ends. If the determination is affirmative in S1, in S2, the area AR2 is set in front of the subject vehicle 101 as the acquisition area. Thus, when the process of FIG. 5 is executed next time, the process of S1 is performed based on the area AR2.

Next, in S3, it is determined whether a route change is necessary. For example, when the object acquired in S1 is the other vehicle 102 traveling in an adjacent lane closer to the current lane and there is a possibility that the subject vehicle 101 passes the side of the other vehicle 102, it is determined that a route change is necessary. More specifically, when the distance between the subject vehicle 101 and the other vehicle 102 in the vehicle widthwise direction is less than the predetermined length TW1 and the relative speed of the subject vehicle 101 relative to the other vehicle 102 is equal to or higher than the predetermined speed, it is determined that the route change is necessary. Incidentally, when the recognition accuracy is equal to or less than the threshold TH2 (>TH1), since there is a possibility that the distance in the vehicle width direction between the subject vehicle 101 and the other vehicle 102 is not accurately recognized, even if the distance is less than a predetermined length TW1, it is determined that the route change is not necessary.

If the determination is negative in S3 the process proceeds to S8. If the determination is affirmative in S3, in S4, it is determined whether the path change is possible. For example, when there is a parked vehicle on the left side (road shoulder) of the lane LN1 of FIG. 2, and there is a possibility of approaching or contacting the parked vehicle when the route change is performed, it is determined that the route change is impossible. When the degree of approach between the subject vehicle 101 and the other vehicle 102 in the front-rear direction is equal to or more than a predetermined value, specifically, when the relative distance between the subject vehicle 101 and the other vehicle 102 is less than the predetermined distance TL, it may be determined that the subject vehicle 101 cannot avoid the other vehicle 102 and that the route change is impossible.

If the determination is affirmative in S4, the route change control is started in S5, and the process ends. At this time, when the route change control has already been started, the route change control is continuously performed. If the determination is negative in S4, in S6, it is determined whether the subject vehicle 101 can stop behind the object with a deceleration less than the maximum deceleration (the maximum deceleration allowed from the viewpoint of safety in the subject vehicle 101). If the determination is negative in S6, in S7, the subject vehicle 101 starts the stop control so as to stop decelerating at the maximum deceleration, and ends the process. At this time, when the stop control has already been started, the stop control is continuously performed. If the determination is affirmative in S6, the process proceeds to S8.

In S8, it is determined whether pre-deceleration (deceleration by a small deceleration unnoticeable to the occupant) is necessary. Specifically, when the distance in the vehicle width direction of the subject vehicle 101 and the other vehicle is less than the predetermined length TW2 (>TW1) and the relative speed is equal to or higher than the predetermined speed, it is determined that the pre-deceleration is required. As described above, the necessity of the pre-deceleration is determined by using the threshold value TW2 larger than the threshold value TW1 used for the determination of the necessity of the route change, whereby the pre-deceleration is performed prior to the route change. As a result, it is possible to suppress the hunting of the route change as described above, which may occur when the position of the object in the vehicle width direction cannot be accurately recognized. Incidentally, when the recognition accuracy is equal to or less than the threshold TH2, as described above, there is a possibility that the distance in the vehicle width direction between the subject vehicle and the other vehicle is not accurately recognized, so that it is determined that the pre-deceleration is required even if the distance is equal to or greater than a predetermined length TW2.

If the determination is negative in S8, the process ends. If the determination is affirmative in S8, in S9, the deceleration control (pre-deceleration control) by a small deceleration is started, and the process ends. At this time, when the pre-deceleration control is already started, the pre-deceleration control is continuously performed. In the pre-deceleration control, the actuators AC are controlled so that the vehicle 101 decelerates at a deceleration DR that is small enough not to turn the tail light (brake lamp) on. Further, in the pre-deceleration control, as a result of decelerating the subject vehicle 101 at the deceleration DR, when the relative speed with the other vehicle reaches a predetermined speed, the actuators AC are controlled so that the deceleration becomes 0, that is, the subject vehicle 101 travels at a constant speed.

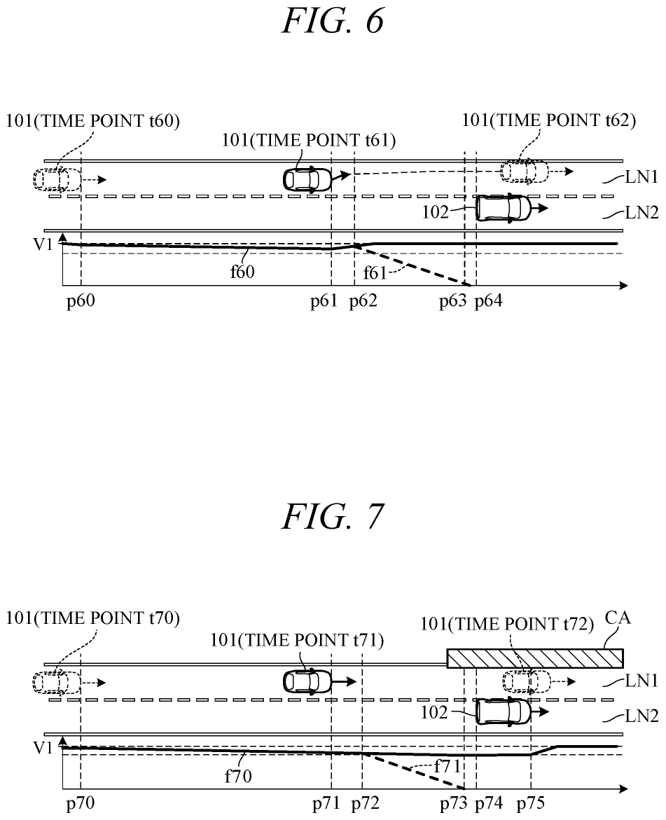

The operation of the driving control apparatus 50 according to the present embodiment is summarized as follows. FIGS. 6 to 10 are diagrams for explaining the operation of the driving control apparatus 50. FIG. 6 illustrates an exemplary operation when the subject vehicle 101 traveling in a lane LN1 performs a route change and passes through the side of the other vehicle 102 traveling in a lane LN2. The characteristic f60 indicates the relationship between the vehicle speed and the position when the subject vehicle 101 passes through the side of the other vehicle 102. The characteristic f61 indicates a relationship between the vehicle speed and the position of the subject vehicle 101 when the subject vehicle 101 cannot pass the side of the other vehicle 102 and stops behind the other vehicle 102.

When the subject vehicle 101 is traveling at the constant speed which is the vehicle speed V1 and recognizes the other vehicle 102 traveling on the adjacent lane LN2 at the vehicle speed V2 (<V1) while the host vehicle is traveling at the constant speed which is the vehicle speed V1 (time point t60, position p60), the driving control apparatus 50 starts the deceleration control (S1 to S3, S8, S9).

Thereafter, as the subject vehicle 101 approaches the other vehicle 102, the position and vehicle speed of the other vehicle 102 are more accurately recognized. When it is determined that the route change is possible (position p61, time point t61), the driving control apparatus 50 starts the route change control (S3, S4, S5). Through the route change control, the subject vehicle 101 accelerates to the original vehicle speed V1 while changing the route so that the distance between the subject vehicle 101 and the other vehicle 102 in the vehicle width direction is equal to or greater than a predetermined length. Then, the driving control apparatus 50, when the front end position of the subject vehicle 101 passes through the front end position of the other vehicle 102 (time point t62), and terminates a series of processing with the other vehicle 102 as an object. At this time, the area AR1 is set again as the acquisition area. When it is determined that the other vehicle 102 cannot pass the side of the other vehicle 102 is too close to the lane LN1 (position p62), the stop control is started (S4, S6, S7) so as to stop the subject vehicle 101 at a position p63 behind a predetermined distance from the rear end position p64 of the other vehicle 102.

In FIG. 7, an example of the operation in a case where the space for the route change cannot be secured when the subject vehicle 101 passes the side of the other vehicle 102 is shown. The characteristic f70 indicates the relationship between the vehicle speed and the position of the subject vehicle 101 when the subject vehicle 101 passes the side of the other vehicle 102. The characteristic f71 indicates a relationship between the vehicle speed and the position of the subject vehicle 101 when the subject vehicle 101 cannot pass the side of the other vehicle 102 and stops behind the other vehicle 102. The driving control apparatus 50 recognizes the other vehicle 102 traveling at the vehicle speed V2 on the adjacent lane LN2 closer to the lane LN1 in the capturing area (the area AR1) when the subject vehicle 101 is running at the constant speed with the vehicle speed V1 (the position p70, the time t70), and then starts the deceleration control (S1 to S3, S8, S9).

In the example shown in FIG. 7, since the construction area CA is provided on the left side (upper side in the figure) of the lane LN1, there is no space for the subject vehicle 101 to change the route. Therefore, the driving control apparatus 50, without executing the route change control (time point t71), executes the deceleration control so that the subject vehicle 101 passes the side of the other vehicle 102 while the subject vehicle 101 is decelerated (S3, S4, S6, S8, S9). Then, when the front end position of the subject vehicle 101 passes through the front end position of the other vehicle 102 (time point t72), the driving control apparatus 50 terminates a series of processes with the other vehicle 102 as an object. At this time, the area AR1 is set again as the acquisition area. Thereafter, the subject vehicle 101 starts acceleration control and starts constant speed running when the vehicle speed reaches the speed V1. When it is determined that the subject vehicle 101 cannot pass the side of the other vehicle 102 since the other vehicle 102 is too close to the lane LN1 (position p72), the stop control is started (S4, S6, S7) so as to stop the subject vehicle 101 at a position p73 behind a predetermined distance from the rear end position p74 of the other vehicle 102.

FIG. 8 illustrates an exemplary operation when the subject vehicle 101 traveling in the lane LN1 passes the side of the other vehicle 102 traveling in the lane LN2 in front of the intersection IS. In the example shown in FIG. 8, the traffic signal SG is installed at the intersection IS, the traffic signal SG is displaying a stop signal (red signal) indicating a stop instruction at the stop line SL.

When it is determined that it is necessary to stop the subject vehicle 101 on the stop line SL according to the stop signal of the traffic signal SG, the driving control apparatus 50 maintains the constant speed travel control so that the subject vehicle 101 travels at a constant speed to the position p82 after the subject vehicle 101 passes the side of the other vehicle 102. Thus, when it is obvious that the subject vehicle 101 stops after passing the side of the other vehicle 102, the driving control apparatus 50 suppresses the acceleration control after passing the side of the other vehicle 102. The characteristic f80 shows the relationship between the vehicle speed and the position of the subject vehicle 101 when the suppression of the acceleration control after passing is performed. The characteristic f81 shows the relationship between the vehicle speed and the position of the subject vehicle 101 when the suppression of the acceleration control after passing is not performed. As shown in the characteristic f81, when not suppressing the acceleration control after passing, immediately after the acceleration control is started at the position p80, the stop control for stopping the subject vehicle 101 at the stop line SL is started at the position p81. Such unnecessary acceleration and deceleration may deteriorate the ride comfort of the occupant. The driving control apparatus 50, in order to prevent such deterioration of the riding comfort of the occupant, suppresses the acceleration control after passing as shown in the characteristic f80.

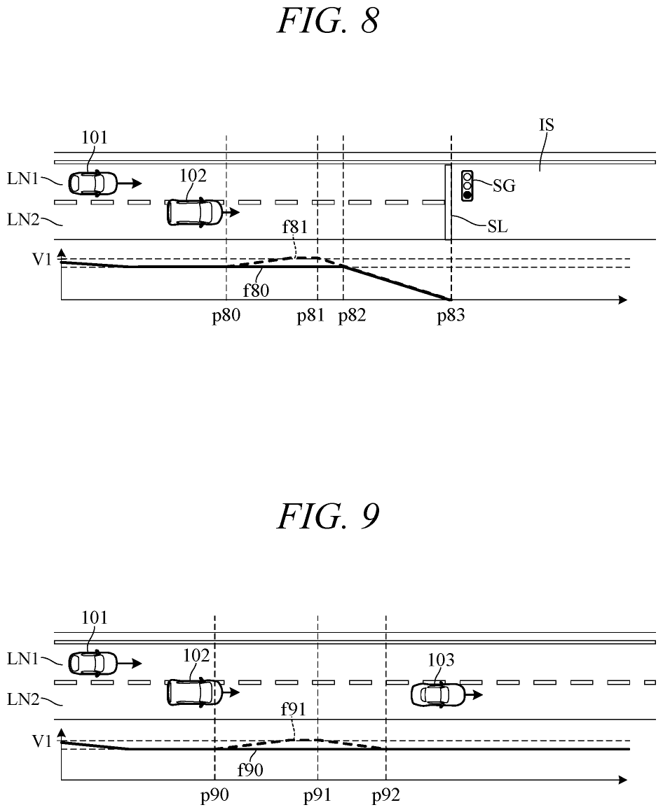

FIG. 9 illustrates an exemplary operation when the subject vehicle 101 traveling in the lane LN1 passes the side of the other vehicles 102 and 103 traveling in a lane LN2. The characteristics f90 and f91 show the relation between the vehicle speed and the position of the subject vehicle 101 when the subject vehicle 101 passes through the other vehicles 102 and 103.

When the other vehicle 103 is present in front of the other vehicle 102, the driving control apparatus 50 maintains the constant speed travel to the position p92 without performing acceleration control after passing through the side of the other vehicle 102, as shown in the characteristic f90. As described above, when it is obvious that the subject vehicle 101 decelerates again after passing the side of the other vehicle 102, acceleration control after passing is suppressed. The characteristic f91 shows the relationship between the vehicle speed and the position of the subject vehicle 101 when the suppression of the acceleration control after passing is not performed. As shown in the characteristic f91, immediately after the acceleration control after passing is started at the position p90, the deceleration control for passing through the side of the other vehicle 103 at the position p91 is started. Therefore, if the acceleration control after passing is not suppressed, unnecessary acceleration and deceleration occurs, which may deteriorate the riding comfort of the occupant. The driving control apparatus 50, in order to prevent such deterioration of the riding comfort of the occupant, suppresses the acceleration control after passing as shown in the characteristic f90.

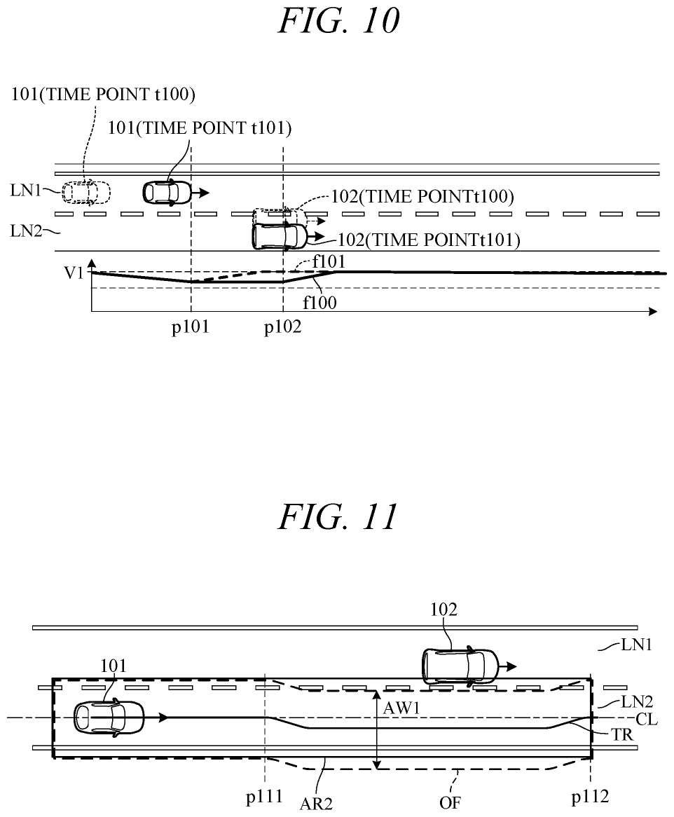

FIG. 10 shows an example of the driving operation of the vehicle when the object deviates from the acquisition area. In the exemplary embodiment shown in FIG. 10, at a time t100 prior to the time t101 at which the subject vehicle 101 reaches the position p101, the other vehicle 102 is acquired within the acquisition area (area AR1) and the deceleration control is started (S1 to S3, S8, S9). It is assumed that the other vehicle 102 is not included in the acquisition area at the time point t100, but is recognized and acquired at a position closer to the lane LN1 than the actual position by the recognition error of the recognition unit 141.

It becomes clear that the other vehicle 102 is traveling in the center of the lane LN2 because the recognition accuracy of the other vehicle 102 is improved when the subject vehicle 101 approaches the other vehicle 102 (position p101), and then, the driving control apparatus 50 stops the deceleration control. At this time, the driving control apparatus 50 immediately starts the acceleration control so as to return the vehicle speed of the subject vehicle 101 to the speed before the start of the deceleration control. The characteristic f101 shows the relation between the vehicle speed and the position of the subject vehicle 101 in the case where the driving control apparatus 50 immediately starts the acceleration control like this. However, if the vehicle is immediately switched from the deceleration control to the acceleration control at the time when it becomes clear that the other vehicle 102 is traveling in the center of the lane LN2, the ride comfort of the occupant may be deteriorated. Therefore, in order to prevent such deterioration of the riding comfort, even when the recognition accuracy of the other vehicle 102 is improved and it is determined that the deceleration control is not required, the driving control apparatus 50 does not immediately start the acceleration control, and starts the acceleration control after performing the constant speed travel control for a predetermined time or a predetermined distance. The characteristic f100 shows the relation between the vehicle speed and the position of the subject vehicle 101 in the case where the driving control apparatus 50 does not immediately start the acceleration control like this. As shown in the characteristic f100, the constant speed travel control is carried out in the section from the position p101 to the position p102.

According to the embodiment of the present invention, the following operations and effects can be obtained:

(1) The driving control apparatus 50 includes a camera 1a configured to detecting (imaging) a situation around the subject vehicle 101, a recognition unit 141 that recognizes an object in a predetermined area set in front of the subject vehicle 101 based on the situation detected by the camera 1a, the area setting unit 142 that calculates the reliability of the recognition result of the object by the recognition unit 141, and a driving control unit 161 that controls the actuators AC for traveling based on the recognition result of the object by the recognition unit 141. the driving control unit 161 controls, when the reliability calculated by the area setting unit 142 is equal to or less than a predetermined value (threshold TH2), the actuators AC so that the subject vehicle 101 approaches the object recognized by the recognition unit 141 while decelerating with a predetermined deceleration (deceleration by a small deceleration unnoticeable to the occupant), that is, while performing the pre-decelerating, while the driving control unit 161 controls, when the reliability calculated by the area setting unit 142 is larger than the threshold TH2, the actuators AC so that the subject vehicle 101 approaches the object while performing the route change based on the position of the subject vehicle 101 and the object. Thus, when the position in the vehicle width direction of the forward vehicle cannot be accurately recognized by the sensor error of the camera 1a, the deceleration traveling at a minute deceleration is performed with priority over the route change. Then, when the position in the vehicle width direction of the forward vehicle is accurately recognized, it is determined that the forward vehicle is traveling reliably close to the current lane side, the route change is performed. With such a travel control, it is possible to suppress a traveling operation that may cause psychological compression or discomfort to the occupant, such as hunting of acceleration and deceleration or hunting of route change, which may occur when the other vehicle is recognized in front of the subject vehicle.

(2) When the reliability calculated by the area setting unit 142 is larger than the threshold TH2 and the distance in the vehicle width direction between the subject vehicle 101 and the object is less than the first threshold value (threshold TW1), the driving control unit 161 controls the actuators AC so as to move the traveling position of the subject vehicle 101 in a direction in which the distance in the vehicle width direction between the subject vehicle 101 and the object increases to perform the approach travel. Further, when the reliability is larger than the second threshold value (threshold value TH2) and the distance in the vehicle width direction between the subject vehicle 101 and the object is equal to or larger than the threshold value TW1 and equal to or less than the threshold value TW2, the driving control unit 161 controls the actuators AC so that the subject vehicle 101 performs the approach travel at the predetermined deceleration. As a result, the route change is executed at the timing when it is determined that the route change is necessary, and the occurrence of hunting of the route change can be further suppressed.

(3) The driving control apparatus 50 includes a camera 1a configured to detect (imaging) a situation around the subject vehicle 101, a recognition unit 141 that recognizes an object in a predetermined area set in front of the subject vehicle 101 based on the situation detected by the camera 1a, the driving control unit 161 that controls an traveling actuator based on the recognition result of the object by the recognition unit 141, and the area setting unit 142 that sets a predetermined area such that the length of the predetermined area in the vehicle width direction at a position that is apart from the subject vehicle 101 by a first distance (e.g., the width AW1 at the position p11 in FIG. 4A) is longer than the length of the predetermined area in the vehicle width direction at a position that is apart from the subject vehicle 101 by a second distance longer than the first distance(e.g., the width AW2 at the position p21 in FIG. 4A). Thus, it is possible to suppress a driving operation that may cause psychological compression or discomfort to the occupant, such as hunting of acceleration and deceleration or hunting of route change that occurs due to misrecognition of the position of the object distant from the subject vehicle 101, particularly misrecognition of the position in the vehicle width direction. Therefore, as well as enabling safer travel, it is possible to improve the riding comfort of the occupant. In addition, the hunting of acceleration and deceleration and hunting of route changes is suppressed, which leads to efficient driving operations. As a result, it is possible to reduce the environmental burden, such as reducing CO2 emissions.

(4) The predetermined area is a first area (area AR1). The area setting unit 142, until the object is recognized by the recognition unit 141, sets the area AR1 as the predetermined area, and when the object is recognized, sets the second area (area AR2) whose length in the vehicle-widthwise at a position the is apart from the subject vehicle 101 by the second distance is longer than the area AR1. This makes it easier for an object that has been acquired once to be subsequently continuously acquired, thereby enabling safer driving.

(5) The area setting unit 142 calculates the reliability of the recognition result of the object, and sets the area AR1 as the predetermined area when the reliability is less than a predetermined threshold TH1, and sets the area AR2 as the predetermined area when the reliability becomes equal to or larger than the threshold TH1. Therefore, it possible to set the acquisition area in consideration of the recognition accuracy of the object, and to reduce the frequency at which a distant object is erroneously acquired. Thereby, it is possible to further suppress hunting of acceleration and deceleration or hunting of route change caused by misrecognition of the position of the distant object.

(6) The longer the relative distance to the object, the lower reliability the area setting unit 142 calculates. Thus, the longer the relative distance between the object and the subject vehicle is the more difficult it becomes to acquire the object, it is possible to further suppress hunting of acceleration and deceleration or hunting of route change generated by erroneous recognition of the position of the distant object.

The above-described embodiment can be modified into various forms. Hereinafter, some modifications will be described. In the embodiment described above, the camera 1a is configured to detect the situation around the subject vehicle, as long as the situation around the vehicle is detected, a configuration of an in-vehicle detector may be any configuration. For example, the in-vehicle detector may be a radar or a Lider.

In the above-described embodiment, the recognition unit 141 recognizes the vehicle as an object, the driving control unit 161 controls the actuators AC so that the subject vehicle passes through the side of a vehicle recognized by the recognition unit 141. However, a recognition unit may recognize an object other than the vehicle as an object, and a driving control unit may control the actuator for traveling so that the subject vehicle passes through the side of the object. For example, the recognition unit may recognize a construction section, road cone and a human robot for vehicle guidance which are installed in the construction section, falling objects on the road and so on, as objects. Further, in the above-described embodiment, the area setting unit 142 is configured to calculate the recognition accuracy (reliability) based on the captured image of the camera 1a as a reliability calculation unit, a configuration of the reliability calculation unit is not limited to this, the reliability calculation unit may be provided separately from the area setting unit 142. Further, the reliability calculation unit may calculate the reliability based on the data acquired by the radar or the Lidar. Furthermore, the reliability calculation unit, based on the type and the number of the in-vehicle detection unit (camera, radar, Lidar), may be changed reliability calculated in accordance with the relative distance to the object. For example, the reliability calculated when the camera, the radar, and the Lidar are used as in-vehicle detection units may be calculated higher than when only the camera is used as an in-vehicle detection unit. Further, the reliability may be calculated higher when using a plurality of cameras than when using only one camera. As a method of changing the reliability, a coefficient determined in advance based on the performance of a camera, a radar, or a Lidar may be multiplied by the reliability, or other methods may be used.

Further, in the above-described embodiment, the case in which the road on which the subject vehicle 101 travels is a straight road is taken as an example, but the driving control apparatus 50 similarly performs the processing of FIG. 5 to control the driving operation of the subject vehicle 101 even when the subject vehicle 101 is traveling on a road of another shape (such as a curve). In this case, the acquisition area (area AR1, area AR2) is set along the center line of the lane in the same manner as in the examples shown in FIGS. 4A and 4B. Specifically, the recognition unit 141 recognizes the shape of the road ahead of the subject vehicle 101 based on the surrounding situation detected by the camera 1a, and the area setting unit 142 sets the acquisition area based on the shape of the road recognized by the recognition unit 141 so that the center position in the vehicle width direction of the acquisition area overlaps the center line of the own lane. Thus, the acquisition area to match the shape of the road is set. Further, in the above-described embodiment, the case in which the subject vehicle 101 is traveling on a road having two lanes on one side is taken as an example, but the driving control apparatus 50 similarly performs the processing of FIG. 5 to control the driving operation of the subject vehicle 101 when the subject vehicle 101 is traveling on a road having three or more lanes on one side. In this case, when there are adjacent lanes on both sides of the lane in which the subject vehicle 101 travels, for example, when the subject vehicle 101 is traveling in the center lane of the road having three lanes on one side, in consideration of safety, it may always be determined that the route cannot be changed in Step S4.

In the above-described embodiment, when the object is acquired, the area setting unit 142 expands the acquisition area by switching the acquisition area from the area AR1 to the area AR2. However, a configuration of an area setting unit is not limited to this.

For example, the area setting unit may correct (offset) the position (the position in the vehicle width direction) of the area AR2 considering the movement amount in the vehicle width direction of the travel route by the route change control when the travel route of the subject vehicle 101 is changed by performing the route change control. Specifically, when the travel path is moved in a direction away from the object in the vehicle width direction by the route changing control, the area setting unit may be set the position of the area AR2 so that the area AR2 moves in the vehicle width direction by the amount of movement (offset amount). FIG. 11 is a diagram for explaining offsets of the acquisition area (area AR2). In FIG. 11, in a situation as shown in FIG. 4B, a state in which the subject vehicle 101 changes the route to the right side (the lower side of FIG. 4B) so as to be away from the other vehicle 102 in a range from the position p111 to the position p112 is shown. The solid line TR represents the travel route (target travel route) of the subject vehicle 101. In addition, the area OF indicated by the broken line schematically represents the area AR2 offset along the travel rout TR of the subject vehicle 101. As shown in FIG. 11, when the subject vehicle 101 changes the route, the area setting unit corrects (offsets) the position of the area A so that the center position of the area AR2 overlaps the travel route TR. Thus, since the acquisition area is set to an appropriate position even when the subject vehicle 101 changes the route, a safer driving operation can be performed.

Further, for example, the area setting unit, when the recognition unit recognizes that the other vehicle (the preceding vehicle traveling in front of the vehicle lane) can pass through the side of the object without route change and deceleration, may reduce the acquisition area so as to narrow the acquisition area in the vehicle width direction. Thus, when the subject vehicle 101 passes the side of the object, unnecessary route change and deceleration can be suppressed, thereby it is possible to improve the riding comfort of the occupant and to realize reducing the environmental burden such as reducing the emission of CO2. Instead of the area setting unit reducing the acquisition area, the driving control unit may not perform the route change control and deceleration control.

Further, in the above-described embodiment, the driving control apparatus 50 is applied to the self-driving vehicle, the driving control apparatus 50 is also applicable to vehicles other than the self-driving vehicle. For example, it is possible to apply the driving control apparatus 50 to manual driving vehicles provided with ADAS (Advanced driver-assistance systems). Furthermore, by applying the driving control apparatus 50 to a bus or a taxi or the like, it becomes possible that the bus or taxi smoothly passes the side of the other vehicle, it is possible to improve the convenience of the public transportation. In addition, it is possible to improve the riding comfort of the occupants of buses and taxis.

It is possible to arbitrarily combine one or more of the above-described embodiments and variations, and it is also possible to combine variations with each other.

The present invention also can be configured as a driving control method including: recognizing an object in a predetermined area set in front of a vehicle base on the situation detected by the in-vehicle detector configured to detecting a situation around the vehicle; calculating a reliability of a recognition result of the object in the recognizing; and controlling an actuator for traveling based the recognition result, wherein the controlling including controlling, when the reliability calculated in the calculating is equal to or less than a predetermined value, the actuator so that the vehicle approaches the object recognized in the recognizing with a predetermined deceleration, while controlling, when the reliability calculated in the calculating is larger than the predetermined value, the actuator so that the vehicle approaches the object based on the position of the vehicle and the object.

According to the present invention, it is possible to appropriately perform travel control when another vehicle is present in front of the subject vehicle.

Above, while the present invention has been described with reference to the preferred embodiments thereof, it will be understood, by those skilled in the art, that various changes and modifications may be made thereto without departing from the scope of the appended claims.

What is claimed is:

1. A driving control apparatus comprises:
an in-vehicle detector configured to detecting a situation around a vehicle; and
a microprocessor and a memory coupled to the microprocessor, wherein
the microprocessor is configured to perform:
recognizing an object in a predetermined area set in front of the vehicle base on the situation detected by the in-vehicle detector;
calculating a reliability of a recognition result of the object in the recognizing; and
controlling an actuator for traveling based the recognition result, wherein
the microprocessor is configured to perform
the controlling including controlling, when the reliability calculated in the calculating is equal to or less than a predetermined value, the actuator so that the vehicle approaches the object recognized in the recognizing with a predetermined deceleration, while controlling, when the reliability calculated in the calculating is larger than the predetermined value, the actuator so that the vehicle approaches the object based on the position of the vehicle and the object.

2. The driving control apparatus according to claim 1, wherein
the microprocessor is configured to perform
the controlling including controlling, when the reliability calculated in the calculating is larger than the predetermined value and a distance in a vehicle width direction between the vehicle and the object is less than a threshold value, the actuator so as to move a traveling position of the vehicle in a direction in which the distance increases to approach the object the traveling position.

3. The driving control apparatus according to claim 2, wherein
the threshold value is a first threshold value, and
the microprocessor is configured to perform
the controlling including controlling, when the reliability is greater than a second threshold value and the distance and the object is equal to or greater than the first threshold value and equal to or less than the second threshold value, the actuator so that the vehicle approaches at the predetermined deceleration.

4. The driving control apparatus according to claim 3, wherein
the microprocessor is configured to perform
the calculating includes calculating the reliability lower as a relative distance by the object in the traveling direction is longer.

5. The driving control apparatus according to claim 4, wherein
the microprocessor is configured to perform
the calculating includes varying the reliability calculated based on the relative distance based on a type and number of the in-vehicle detector.

6. The driving control apparatus according to claim 1, wherein
the microprocessor is further configured to perform
setting the predetermined area so that a length of the predetermined area in the vehicle width direction at a position apart from the vehicle by a first distance is shorter than a length of the predetermined area in the vehicle width direction at a position away from the vehicle by a second distance is longer than the first distance.

7. The driving control apparatus according to claim 6, wherein
the predetermined area is a first area, and
the microprocessor is further configured to perform
the setting includes setting, until the object is recognized in the recognizing, the first area in front of the vehicle, while setting, when the object is recognized in the recognizing, a second area in front of the vehicle, whose length in the vehicle-widthwise direction at a position away from the vehicle by second distance is longer than the first area.

8. The driving control apparatus according to claim 7, wherein
the microprocessor is configured to perform
the setting includes setting the second area so that a rear end portion of the second area is positioned at a position away from the vehicle by a third distance in a opposite to the traveling direction.

9. The driving control apparatus according to claim 8, wherein
the microprocessor is configured to perform
the setting includes setting the first area in front of the vehicle when the reliability calculated in the calculating is less than a threshold, while setting the second area in front of the vehicle when the reliability calculated in the calculating is more than or equal to the threshold.

10. The driving control apparatus according to claim 7, wherein
the microprocessor is configured to perform
the recognizing includes recognizing a shape of a road in front of the vehicle
based on the surrounding situation detected by the in-vehicle detector, and
the setting includes setting the first and the second areas so that center positions of the first and the second areas overlap a center position of a current lane in which the vehicle is traveling based on the shape of the road recognized in the recognizing.

11. The driving control apparatus according to claim 10, wherein
the microprocessor is configured to perform
the setting includes correcting a position of the second area in the vehicle width based on a movement amount in the vehicle width of a driving route of the vehicle.

12. A driving control method comprises:
recognizing an object in a predetermined area set in front of a vehicle base on the situation detected by the in-vehicle detector configured to detecting a situation around the vehicle;
calculating a reliability of a recognition result of the object in the recognizing; and
controlling an actuator for traveling based the recognition result, wherein
the controlling including controlling, when the reliability calculated in the calculating is equal to or less than a predetermined value, the actuator so that the vehicle approaches the object recognized in the recognizing with a predetermined deceleration, while controlling, when the reliability calculated in the calculating is larger than the predetermined value, the actuator so that the vehicle approaches the object based on the position of the vehicle and the object.
